(19) United States
(12) Patent Application Publication
(10) Pub. No.: US 2021/0125349 A1
(43) Pub. Date: Apr. 29, 2021

(54) SYSTEMS AND METHODS FOR VISUALIZING BALL TRAJECTORY IN REAL-TIME

(71) Applicant: Ji Eul Song, Gimpo (KR)

(72) Inventor: Ji Eul Song, Gimpo (KR)

(21) Appl. No.: 16/663,874

(22) Filed: Oct. 25, 2019

(51) Int. Cl. G06T 7/292; G06T 7/70; G06T 7/55; H04N 5/247; H04N 21/44

(52) U.S. Cl. CPC G06T 7/292; G06T 7/70; G06T 7/55; G06T 2207/10012; H04N 21/44; G06T 2207/30224; G06T 2207/30241; H04N 5/247

(57) ABSTRACT

Systems and methods for visualizing a ball trajectory in real-time. A method includes: preparing a plurality of images of a ball, each image of the plurality of images of the ball corresponding to a distance from a reference point; determining a position of the ball to determine a distance between the ball and the reference point; selecting an image among the plurality of images, wherein the selected image corresponds to the determined distance; using the selected image and determined position, rendering an image of the ball to be displayed on a screen; and transmitting the rendered image to a broadcast apparatus that broadcasts the rendered image in real-time. The images of the ball are rendered and broadcasted multiple times during a time interval so that a sequence of ball images displayed on the screen shows the trajectory of the ball in real-time.

### TECHNICAL FIELD

The present invention relates to providing visual images of a ball in motion, more particularly, to systems and methods for visualizing a ball trajectory in real-time.

### B. DESCRIPTION OF THE RELATED ART

With the advent in the field of sports broadcasting technologies, various approaches have been developed to display the progress of a ball game to remote screen viewers. Such approaches include tracking and visualizing of a ball during a game, such as a ball pitched by a pitcher in a baseball game or a cricket game or a ball hit by a golfer in a golf game. FIG. 1 shows a conventional display of a trajectory of a baseball on a screen. As depicted, the line 102 shows the trajectory of the baseball pitched by the pitcher during a game. Typically, the line 102 is generated by connecting the centerlines of the ball images captured in the frames of the motion images, and is superimposed on the image from a sports camera along with the boundary of the strike zone 104.

In general, this conventional approach can display the entire trajectory after the catcher catches the ball. As such, the drawback of this conventional approach is that the screen viewers cannot watch the ball in real-time, i.e., the conventional approach cannot visualize the ball trajectory in a manner that gives more realistic view to the viewers as if the viewers are present in the scene.

Another conventional approach uses a camera that is affixed to the mask of a catcher, allowing the screen viewers to track pitch home and watch the ball from the catcher's viewpoint instead of pitcher's. However, this approach also has drawbacks. First, the catcher may move his head during the play, causing the reference point of the screen image to constantly move according to the catcher's movement and possibly making the viewers feel dizzy. Second, the camera may be damaged and impose danger to the catcher when being advertently hit by the ball and broken. Third, the camera may add extra weight to the mask, interfering with the catcher's movements and performance during the game. In yet another approach, a camera may be affixed to the mask of a home plate umpire. But, this approach may have similar problem as the approach that uses a camera on the catcher's mask.

Accordingly, there is a need for efficient systems and methods for visualizing a ball trajectory in real-time without imposing danger or interference to the players while allowing the viewers to have the more realistic and immersive experience.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a conventional screen image that displays a trajectory of a ball during a game.

FIG. 2 shows a schematic diagram of a system for visualizing a ball trajectory in real-time according to embodiments of the present invention.

FIG. 3 shows a block diagram of a server in FIG. 2 according to embodiments of the present invention.

FIG. 4 shows images of a ball at two locations and a strike zone according to embodiments of the present invention.

FIG. 5 shows a diagram to illustrate an exemplary epipolar geometric structure according to embodiments of the present invention.

FIG. 6 shows a diagram to illustrate coordinate systems in an image geometry according to embodiments of the present invention.

FIG. 7 shows an exemplary screen image captured by a sports camera according to embodiments of the present invention.

FIG. 8 shows an enlarged view of a trajectory display according to embodiments of the present invention.

FIG. 9 shows an enlarged view of a trajectory display according to embodiments of the present invention.

FIG. 10 shows a flowchart of an illustrative process for visualizing a trajectory of a ball in real-time according to embodiments of the present invention.

FIG. 11 shows a computer system according to embodiments of the present invention.

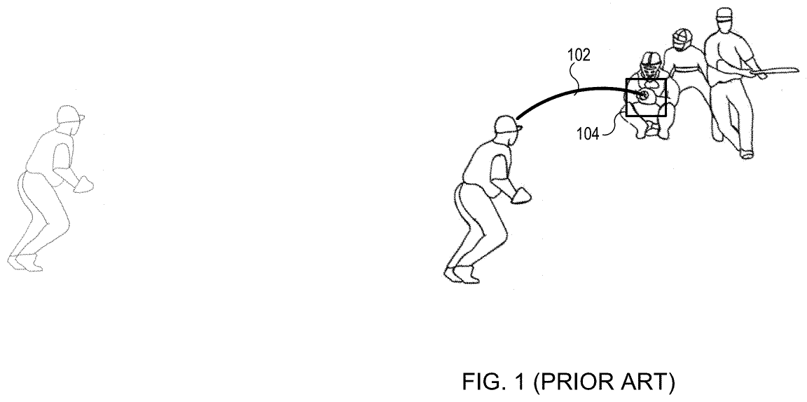

Throughout the drawings and the detailed description, the same reference numerals refer to the same elements. The drawings may not be to scale, and the relative size, proportions, and description of elements in the drawings may be exaggerated for clarity, illustration, and convenience.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a non-transitory computer-readable medium.

Components shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components that may be implemented in software, hardware, or a combination thereof.

It shall also be noted that the terms “coupled” “connected” or “communicatively coupled” shall be understood to include direct connections, indirect connections through one or more intermediary devices, and wireless connections.

Furthermore, one skilled in the art shall recognize: (1) that certain steps may optionally be performed; (2) that steps may not be limited to the specific order set forth herein; and (3) that certain steps may be performed in different orders, including being done contemporaneously.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The present document may provide various implementations to visualize a trajectory of a ball pitched by a pitcher in a way that a viewer can feel more real and present as if he is in the scene. In embodiments, a trajectory of a ball pitched by a pitcher is provided as an image from batter's or catcher's viewpoint instead of pitchers. In broadcasting a baseball game, if a ball pitched by a pitcher is visualized and displayed from a batter's or catcher's viewpoint, a viewer can feel a more realistic and immersive experience. For example, the viewer can even feel the speed of the ball and identify how well the pitch was thrown.

For the purpose of illustration, the systems and methods for visualizing a trajectory of a ball in a baseball game is described below. However, the same systems and methods can be used to visualize trajectories of balls in other types of ball games. For instance, the trajectory of a ball from the cricket bowler may be visualized and displayed from a batsman's viewpoint. In another example, the trajectory of a golf ball hit by a golfer may be visualized and displayed from the golfer's viewpoint.

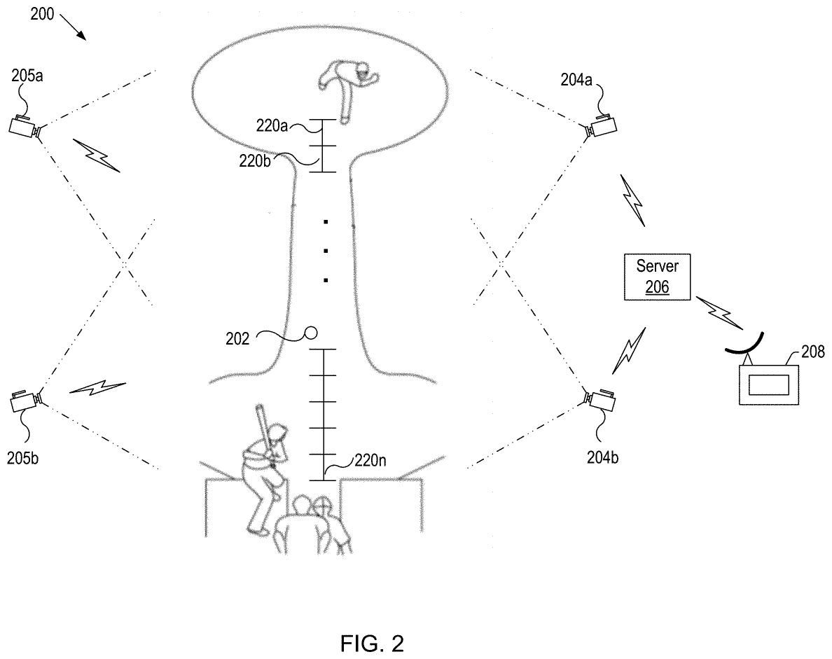

FIG. 2 shows a schematic diagram of a system 200 for visualizing a ball trajectory in real-time according to embodiments of the present invention. As depicted, the system 200 may include: two cameras 204a and 204b for capturing motion images (e.g., motion images of 100 frames per second); a server 206, which may be a computing device, for receiving the motion images from the cameras, determining the position of the ball, and rendering an image of the ball; and a relay station 208 for receiving the rendered image of the server 206 and broadcasting the rendered image to viewers.

In embodiments, the cameras 204a, 204b, 205a and 205b may be located outside the baseball field, preferably in the baseball stands. In embodiments, the motion images from the cameras 204a and 204b may be used to determine the position of the ball when the batter is standing in the left batter box, while the motion images from the cameras 205a and 205b may be used to determine the position of the ball when the batter is standing in the right batter box.

In embodiments, each of the cameras 204a and 204b may capture the motion image that includes an image of the ball 202, and send the captured motion image to the server 206 either wirelessly or by wire. In embodiments, more than two cameras may be used to capture motion images that each include an image of the ball 202. It is noted that other suitable number of cameras may be used in the system 200 and that the cameras may be displaced in various suitable locations for capturing the motion images.

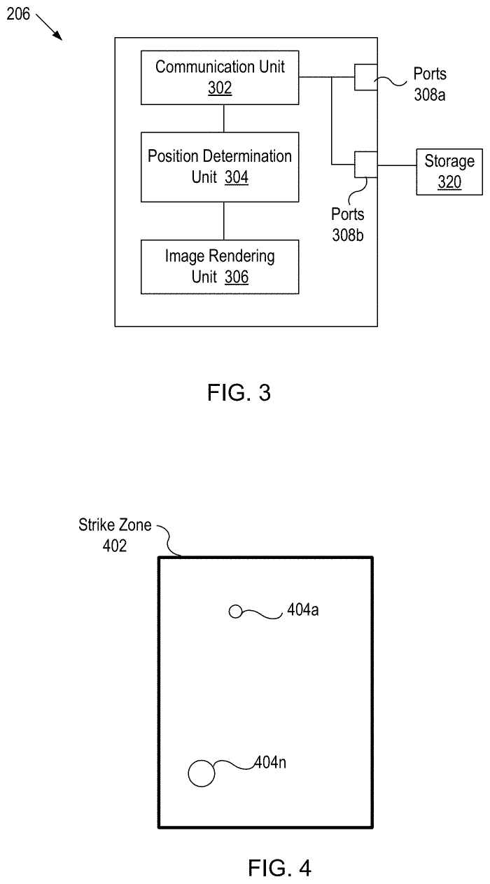

FIG. 3 shows a block diagram of the server 206 in FIG. 2 according to embodiments of the present invention. As depicted, the server 206 may include: a communication unit 302 for controlling data exchange with external devices; and one or more ports 308a and 308b through which the data flows. In embodiments, the communication unit 302 may receive motion images from the cameras 204a and 204b, through the port 308a.

The server 206 may also include: a position determination unit 304 for processing the motion images frame by frame and determining the position of the ball 202 at each frame, as explained in conjunction with FIG. 4; and an image management unit 306 for generating images of the ball 202, based on the determined position of the ball.

In embodiments, the image management unit 306 may prepare a plurality of images of the ball 202 in advance, where each image corresponds to a position of the ball relative to a reference point. In embodiments, the space between the pitcher's plate and home plate in FIG. 2 may be divided into a preset number of intervals 220a-220n. Then, at each interval, preferably at the midpoint of each interval, the size of the ball seen from the catcher or batter may be determined. For instance, the ball may look smaller in the first interval 220a than in the last interval 220n. FIG. 4 shows images of the ball 202 at two locations and a strike zone 402 according to embodiments of the present invention. As depicted, the image of the ball 404a, which corresponds to an image of the ball in the interval 220a, may be larger than the image of the ball 404n, which corresponds to an image of the ball in the interval 220n.

In embodiments, at each of the intervals 220a-220n, an image of the ball may be generated and stored in an external storage 320. In alternative embodiments, the storage 320 may be included in the server 206.

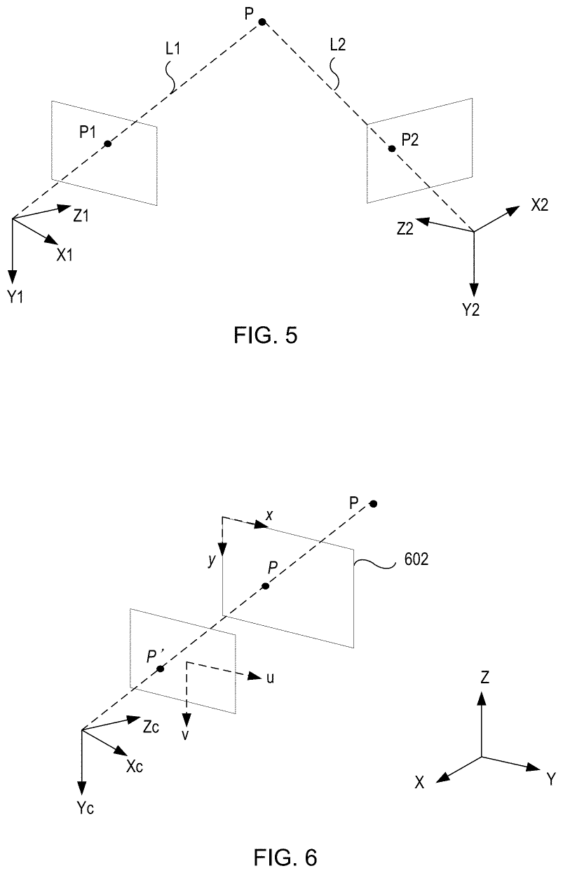

As discussed below in conjunction with FIGS. 5 and 6, the position determination unit 304 may determine a position of the ball using two frames included in two motion images, respectively, where the two frames are taken simultaneously. Upon determining the position of the ball, the image management unit 306 may retrieve one of the ball images that corresponds to the determined position from the storage 320.

In embodiments, upon determining the position of the ball, the image rendering unit 306 may generate an image, e.g. 404a, using the position information and the ball image retrieved from the storage 320 based on the position information. In embodiments, the center of the image 404a may be located at the position determined by the position determination unit 304.

In embodiments, each motion image may include a plurality of frames, which are still images. In embodiments, the position determination unit 304 may select a frame from each motion image received from the camera (e.g. 204a). In embodiments, the position determination unit 304 may use an artificial intelligence (Al) program to recognize an image of the ball in the selected frame, where the Al program may be pre-trained to recognize the images of the ball. In embodiments, the Al program may be also pre-trained to process the frame so as to filter the noise. Upon recognizing an image of the ball, the position determination unit 304 may identify the pixels of the ball image.

As discussed above, in embodiments, the position determination unit 304 may use two frames included in two motion images, respectively, where the two frames are taken simultaneously, and determine the position of the ball using an epipolar geometric structure. The epipolar geometry is the geometry of stereo vision. When cameras view a three-dimensional (3D) scene from two distinct positions, there may be a number of geometric relations between the 3D points and their projections. If intrinsic parameters and extrinsic parameters are determined in a stereo imaging system equipped with the plurality of cameras, it is possible to geometrically predict onto which point in a stereo image each set of 3-dimensional spatial coordinates is projected. The intrinsic parameters may include a focal length, a pixel size, and the like of each of the plurality of cameras. The extrinsic parameters may define spatial conversion relationships between the plurality of cameras, such as a rotation and a movement of each of the plurality of cameras. Such geometric corresponding relationships between the stereo images are referred to as an epipolar structure.

FIG. 5 is a diagram to illustrate one example of an epipolar geometric structure formed between the stereo images obtained from the two cameras 204a and 204b (or 205a and 205b). The epipolar geometric structure geometrically defines a relation regarding how a point in a stereo image is projected on another stereo image. This will be described in more detail below with reference to FIG. 5.

Referring to FIG. 5, a first camera and a second camera may provide a first image (or frame) and a second image (or frame), respectively, and a single point P is projected on the first image and the second image. The single point P is assumed to be projected onto a single point p1 on the first image in a 3-dimensional space. When viewing from the first image, all spatial points on a first straight line L1 connecting the center of a first camera to the single point P in the 3-dimensional space may be projected onto the same single point p1. On the other hand, the single point P and the points on the first straight line L1 in the 3-dimensional space are projected onto different positions on a second image. Thus, the points in the 3-dimensional space, which are projected onto the single point p1 on the first image, are projected onto a straight line in the second image. When a lens of the camera produces a nonlinear distortion, the points in the 3-dimensional space may be projected onto a curved line in the second image. As described above, for the single point p1 projected in the first image, a single point cannot be exactly defined in the second image. The points projected in the first image form the geometric straight line L1. Similarly, the points projected in the second image form a geometric straight line L2. Such a straight line structure is referred to as an epipolar straight line. In estimating a corresponding relation between the stereo images, i.e., the first image and the second image, the epipolar straight line and the epipolar geometric structure may be used to geometrically convert a position of an arbitrary point in the first image or second image into a position in the second or first image. That is, when images of the same object or scene are acquired at two different locations, the epipolar geometric structure defines a geometric relation between the coordinates in the first image and those in the second image.

Such epipolar geometric structure may be expressed by a fundamental matrix. The fundamental matrix is a matrix that represents a geometric relation(s) between pixel coordinates in the first image and pixel coordinates in the second image, such geometric relation including the parameters of the camera. A matrix F satisfying the following Equations 1 and 2 are always present between pixel coordinates p_{img} (=p1) in the first image and pixel coordinates p_{img}, (=p2) in the second image. Such matrix F is referred to as a fundamental matrix.

$$\begin{matrix}{P}_{img}^{′ T} {Fp}_{img} = 0 & Equation 1 \\ [ \begin{matrix}{x}^{′} & {y}^{′} & 1\end{matrix} ] F [ \begin{matrix}x \\ y \\ 1\end{matrix} ] = 0 & Equation 2\end{matrix}$$

When an intrinsic parameter matrix for the first camera in connection with the first image is K, an intrinsic parameter matrix for the second camera in connection with the second image is K′, and an essential matrix between the first image and the second image is E, the fundamental matrix F is represented as the following Equations 3 and 4.

E=K^{T} F K Equation 3

F=(K^{T})⁻¹ E K⁻¹ Equation 4

Eight or more matching pairs of sets of image coordinates may be inputted for the fundamental matrix F. In this case, each set of image coordinates may have two-dimensional image coordinates including an x coordinate and a y coordinate. For example, a coordinate pair, which includes the coordinates of p1 and the coordinates of p2 in FIG. 5, may be a matching pair of sets of image coordinates.

FIG. 6 shows a diagram to illustrate coordinate systems in an image geometry according to embodiments of the present invention. The image geometry may be employed to reflect a view angle, a focal length, and a degree of distortion for each of the image forming modules such as cameras. In FIG. 6, a world coordinate system, a pixel coordinate system, and a normalized coordinate system are shown. When T is a matrix that converts a single point (X, Y, Z) in the world coordinate system into a point (x, y) in an image plane 602 in the pixel coordinate system, its relation may be defined by Equation 5 in terms of homogeneous coordinates.

$$S ( \begin{matrix}x \\ y \\ 1\end{matrix} ) = T [ \begin{matrix}X \\ Y \\ Z \\ 1\end{matrix} ] \qquad Equation 5$$

In Equation 5, T is a 4×3 matrix and may be decomposed and represented as the following Equations 6 and 7.

$$\begin{matrix} S ( \begin{matrix}x \\ y \\ 1\end{matrix} ) = K {T}_{p e r s} ( 1 ) [ R \vert t ] [ \begin{matrix}X \\ Y \\ Z \\ 1\end{matrix} ] & Equation 6 \\ S ( \begin{matrix}x \\ y \\ 1\end{matrix} ) = [ \begin{matrix}{f}_{x} & 0 & {c}_{x} \\ 0 & {f}_{y} & {c}_{y} \\ 0 & 0 & 1\end{matrix} ] [ \begin{matrix}1 & 0 & 0 & 0 \\ 0 & 1 & 0 & 0 \\ 0 & 0 & 1 & 0 \\ 0 & 0 & 0 & 1\end{matrix} ] [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}X \\ Y \\ Z \\ 1\end{matrix} ] & Equation 7\end{matrix}$$

In Equation 6, [R|t] is an extrinsic parameter of the camera, the extrinsic parameter being a rigid transformation matrix that converts the world coordinate system into a plurality of coordinate systems for the camera, Tₚₑᵣₛ(1) is a projection matrix that projects 3-dimensional coordinates in the coordinate system for the camera onto a normalized image plane, and K is an intrinsic parameter matrix for the camera and is used to convert normalized image coordinates into pixel coordinates. Tₚₑᵣₛ(1) is a projection transformation to a plane where the relation Z_{c}=1, i.e., d=1 holds. Therefore, the matrix T, which converts the single point (X, Y, Z) in the world coordinate system into the point (x, y) in an image plane, i.e., in the pixel coordinate system is represented as the following simplified Equation 8.

$$S ( \begin{matrix}x \\ y \\ 1\end{matrix} ) = K [ R \vert t ] [ \begin{matrix}X \\ Y \\ Z \\ 1\end{matrix} ] \qquad Equation 8$$

A correlation between the world coordinate system (X, Y, Z) and the pixel coordinate system (x, y) for each of the plurality of cameras may be derived through the above-described image geometry, and a correlation between the plurality of cameras may be determined through the fundamental matrix F. Through such fundamental matrix F and such image geometry, the position of the ball 202 may be derived. That is, when each of the plurality of cameras 204a and 204b (or 205a and 205b) generates a motion image having multiple frames, a position of the ball 202 may be set for each of the frames through the fundamental matrix F and the relational expression for the above-described matrix T. In embodiments, the origin of the world coordinate system may correspond to a home base of a baseball stadium at which the cameras are installed.

As discussed above, in embodiments, the position determination unit 304 can process the two still images (frames) to determine the position of the ball in a very short time period. Also, upon determining the position, the image management unit 306 can generate the image of the ball (such as 404a) in a very short time since the image of the ball that corresponds to the position can be retrieved from the storage 320. As such, the entire process from capturing the two still images to generating the ball image 404a may be completed without any noticeable delay so that the images of the ball can be generated in real-time. In embodiments, the images of the ball may be generated and displayed on a screen as the ball moves, to thereby visualizing the trajectory of the ball in real-time.

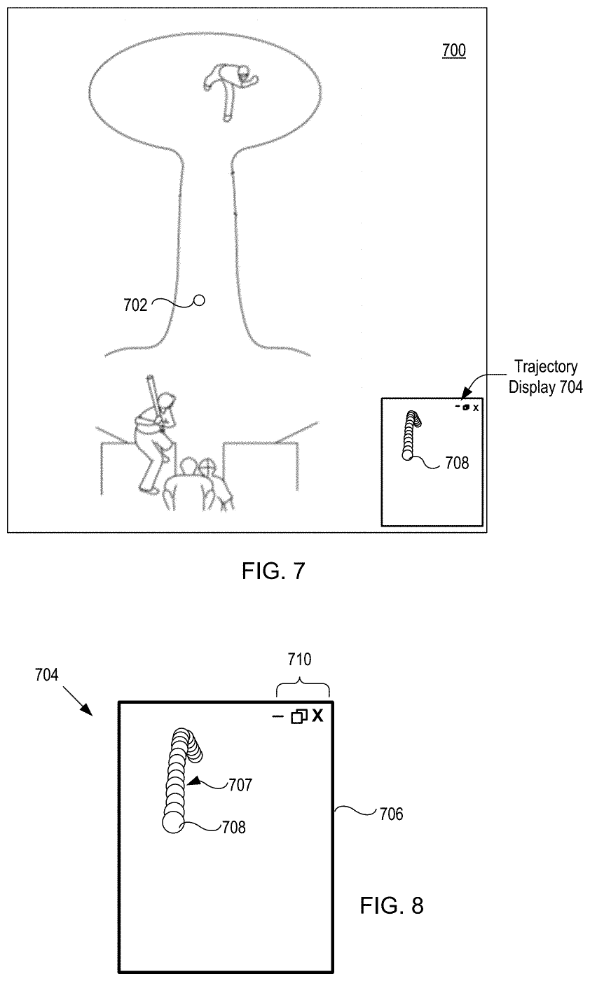

In embodiments, the server 206 may transmit the rendered image of the ball to the relay station 208, where the relay station 208 may relay the images to a broadcast station that broadcasts the images. Hereinafter, the term broadcast apparatus collectively refers to devices that receive the images from the server 206 and broadcast the rendered image to the remote viewers. FIG. 7 shows an exemplary screen image 700 captured by a sports camera according to embodiments of the present invention. FIG. 8 shows an enlarged view of a trajectory display according to embodiments of the present invention. As depicted, a trajectory display 704 may be displayed on the screen image 700. In embodiments, the trajectory display 704 may be located on a corner of the screen image. In embodiments, the trajectory display 704 may include: a rectangle 706 that indicates a strike zone; a sequence of ball images 707; and optionally, one or more buttons 710 for controlling the size of the trajectory display 704.

Unlike the conventional trajectory display systems, in embodiments, the system 200 may be able to generate the sequence of ball images 707 in real-time. By way of example, the ball image 708 may correspond to the ball 702. As discussed above, two still images of the ball 702, which are included in the video images captured by the cameras 204a and 204b, (or 205a and 205b) may be processed to determine the position of the ball 702 and, using the determined position, the image of the ball is rendered and transmitted to the relay station 208. Then, the relay station 208 may display the image of the ball 708 on the trajectory display 704.

In embodiments, the position of the ball may be determined multiple times during the flight of the ball from the pitcher to the catcher. In embodiments, the position of the ball may be determined at each of a plurality of time interval so that a sequence of ball images 707 may be displayed on the trajectory display 704 in real-time. In embodiments, the size of each time interval may be adjusted so that the screen viewer may perceive the sequence of ball images 707 as a trajectory of the ball in real-time and the screen viewer can even feel the speed of the ball and identify how well the pitch was thrown. It is noted that the viewers of the trajectory display 704 may have the more realistic and immersive experience since the sequence of ball images 707 may be displayed in real-time.

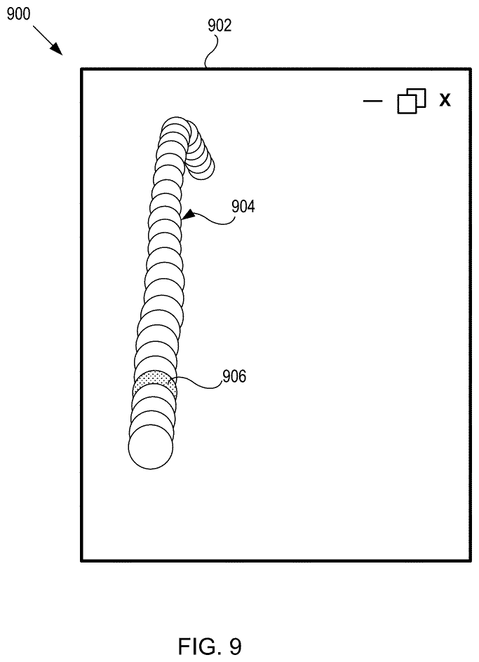

FIG. 9 shows an enlarged view of a trajectory display 900 according to embodiments of the present invention. As depicted, the trajectory display 900 may include: an image of a strike zone 902 and a sequence of ball images 904. The image of the ball 906, which corresponds to the ball at the time when the ball passes through the strike zone 902, may be displayed in a different color and/or shade so that the viewers can recognize whether the pitch is a ball or a strike before the home plate umpire makes a call. Also, the sequence of the ball images 904 may allow the viewers to identify how well the pitch was thrown or the types of pitch, such as fastball, breaking ball, so on.

It is noted that the system 200 may be used to display the trajectory of balls in other types of games. For instance, cameras (such as 204 and/or 205) may be installed in a cricket field and the server 206 may be used to visualize the trajectory of ball as the bowl thrown by the bowler travels to the batsman. In embodiments, the position determination unit 304 may determine the position of the ball using still images, and the image rendering unit 306 may generate the sequence of ball images (similar to the sequence of ball images 707) seen from the batsman's viewpoint, based on the position of the ball.

It is noted that the system 200 may be used to display the trajectory of a golf ball. In embodiments, the cameras (such as 204 and/or 205) may be installed in a golf course and the server 206 may be used to visualize the trajectory of ball as the ball hit by the golfer travels from the tee box. In embodiments, the position determination unit 304 may determine the position of the ball using still images, and the image rendering unit 306 may generate a sequence of ball images (similar to the sequence of ball images 707 or 904), based on the position of the ball.

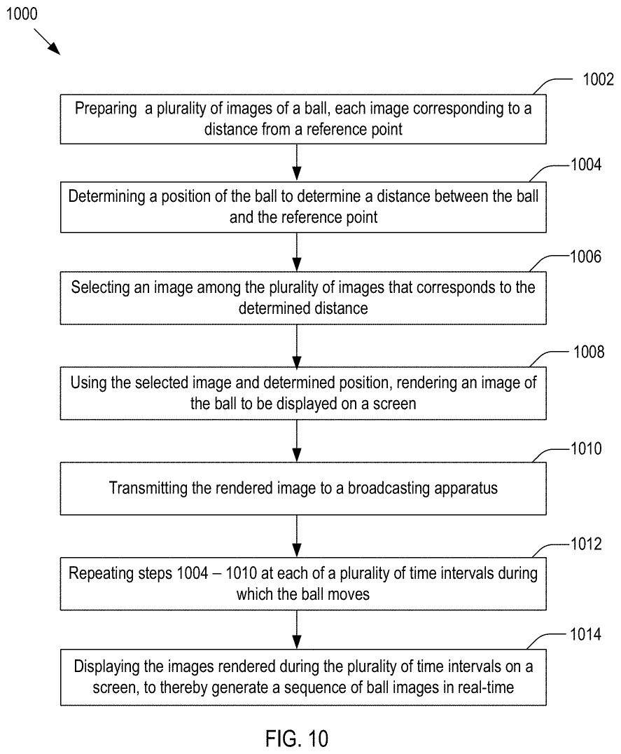

FIG. 10 shows a flowchart of an illustrative process 1000 for visualizing a trajectory of a ball in real-time according to embodiments of the present invention. At step 1002, the server 206, more specifically the image rendering unit 306, may prepare a plurality of images of a ball in advance, each image corresponding to a distance from a reference point. In embodiments, the reference point may be the home plate of the baseball park. In embodiments, the space between the pitcher's plate and home plate may be divided into a preset number of intervals 220a-220n. Then, at each interval, preferably at the midpoint of each interval, the size of the ball seen from the catcher or batter may be determined, and an image of the ball may be rendered and stored in the storage 320.

In embodiments, the reference point may be the batting crease of the cricket field. In embodiments, the space between the batting crease and bowling crease may be divided into a preset number of intervals 220a-220n. Then, at each interval, the size of the ball seen from the batsman may be determined, and an image of the ball may be rendered and stored in the storage 320.

In embodiments, the reference point may be a tee box of a golf course. In embodiments, the space between the tee box and the flagstick of a green may be divided into a plurality of intervals. Then, at each interval, the size of the ball seen from the golf player may be determined, and an image of the golf ball may be rendered and stored in the storage 320.

At step 1004, the position of the ball may be determined at a point in time during the play of the game so that the distance between the ball and the reference point may be determined. In embodiments, various types of measurement devices may be used. For instance, the motion images captured by two or more cameras (204 and/or 205) may be used to determine the position of the ball. In another example, a radar device may be used to determine the position of the ball. It should be apparent to those of ordinary skill in the art that other suitable devices may be used to determine the position of the ball.

At step 1006, an image may be selected among the plurality of images of the ball stored in the storage 320, where the selected image corresponds to the determined distance between the ball and the reference point. Then, at step 1008, an image to be displayed on a screen may be rendered using the selected image and the determined position. For instance, the image of the ball 404n in FIG. 4 may be rendered using the position information and the selected image.

It is noted that the system 200 may be able to render the image (e.g. 404n) using the position information, i.e., the system 200 selects one image among the plurality of images that corresponds to the determined position. Since the process of determining the position may be performed without any noticeable delay, the system 200 may be able to render the image of the ball in real-time.

At step 1010, the rendered image may be transmitted to a broadcast apparatus, which may include the relay station 208, where the broadcast apparatus may broadcast the rendered image to remote viewers. In embodiments, the broadcast apparatus may broadcast a sports camera image 700 that includes the trajectory display 704, where the trajectory display 704 may include the rendered image. At step 1012, the steps 1002-1010 may be repeated at each of a plurality of time intervals during which the ball moves.

At step 1014, the images rendered during the plurality of time intervals may be displayed on a trajectory display 704 (or 900) to thereby generate a sequence of ball images 707 (or 904) in real-time. In embodiments, the screen viewer may use the GUI buttons 710 in the trajectory display 704 to control the size of the trajectory image 704 (or 900). For instance, the screen viewer may expand the trajectory display 704 (or 900) so that the entire screen 700 is occupied by the trajectory display 704 (or 900).

In embodiments, one or more computing system may be configured to perform one or more of the methods, functions, and/or operations presented herein. Systems that implement at least one or more of the methods, functions, and/or operations described herein may comprise an application or applications operating on at least one computing system. The computing system may comprise one or more computers and one or more databases. The computer system may be a single system, a distributed system, a cloud-based computer system, or a combination thereof.

It shall be noted that the present invention may be implemented in any instruction-execution/computing device or system capable of processing data, including, without limitation laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

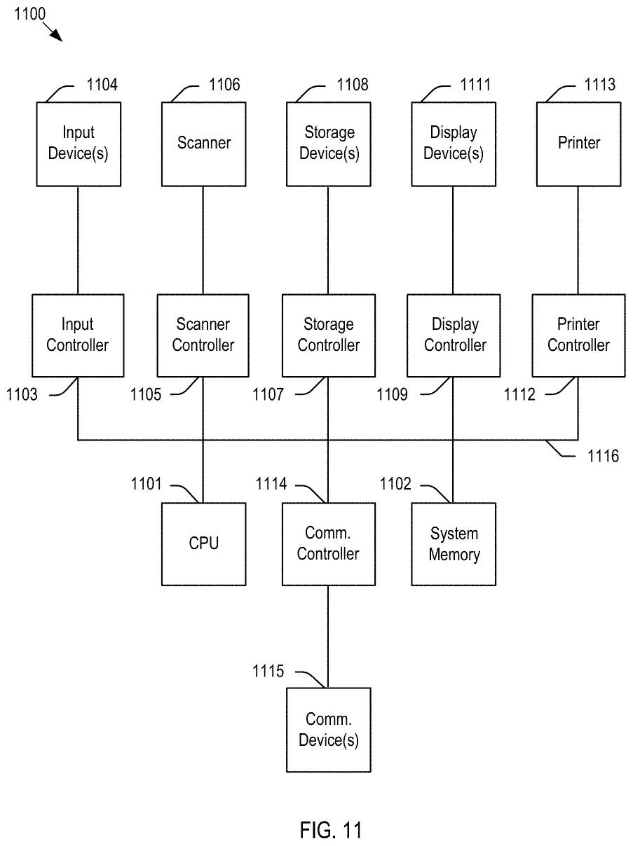

Having described the details of the invention, an exemplary system 1100, which may be used to implement one or more aspects of the present invention, will now be described with reference to FIG. 11. The server 206 in FIG. 2 may include one or more components in the system 1100. As illustrated in FIG. 11, system 1100 includes a central processing unit (CPU) 1101 that provides computing resources and controls the computer. CPU 1101 may be implemented with a microprocessor or the like, and may also include a graphics processor and/or a floating point coprocessor for mathematical computations. System 1100 may also include a system memory 1102, which may be in the form of random-access memory (RAM) and read-only memory (ROM).

A number of controllers and peripheral devices may also be provided, as shown in FIG. 11. An input controller 1103 represents an interface to various input device(s) 1104, such as a keyboard, mouse, or stylus. There may also be a scanner controller 1105, which communicates with a scanner 1106. System 1100 may also include a storage controller 1107 for interfacing with one or more storage devices 1108 each of which includes a storage medium such as magnetic tape or disk, or an optical medium that might be used to record programs of instructions for operating systems, utilities and applications which may include embodiments of programs that implement various aspects of the present invention. Storage device(s) 1108 may also be used to store processed data or data to be processed in accordance with the invention. System 1100 may also include a display controller 1109 for providing an interface to a display device 1111, which may be a cathode ray tube (CRT), a thin film transistor (TFT) display, or other type of display. System 1100 may also include a printer controller 1112 for communicating with a printer 1113. A communications controller 1114 may interface with one or more communication devices 1115, which enables system 1100 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 1116, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A system for visualizing a trajectory of a ball in real-time, comprising:
one or more processors; and
a memory that is communicatively coupled to the one or more processors and stores one or more sequences of instructions, which when executed by one or more processors causes steps to be performed comprising:
(a) preparing a plurality of images of a ball, each image of the plurality of images of the ball corresponding to a distance from a reference point;
(b) determining a position of the ball to determine a distance between the ball and the reference point;
(c) selecting an image among the plurality of images, wherein the selected image corresponds to the determined distance; and
(d) using the selected image and determined position, rendering an image of the ball to be displayed on a screen.

2. The system of claim 1, wherein the steps further comprises:
(e) transmitting the rendered image to a broadcast apparatus.

3. The system of claim 2, wherein the steps further comprises:
(f) repeating steps (a)-(e) at each of a plurality of time interval during which the ball moves.

4. The system of claim 3, wherein the steps further comprises:
displaying the images rendered during the plurality of time interval on the screen, to thereby generate a sequence of ball images on the screen in real-time.

5. The system of claim 1, wherein each of the plurality of images is an image of the ball seen from the reference point.

6. The system of claim 1, wherein the step (b) includes:
receiving two or more motion images from two or more cameras;
identifying images of the ball in two or more frames included in the two or more motion images; and
based on the identified images of the ball, determining the position of the ball.

7. The system of claim 1, wherein the reference point is one of a home plate of a baseball field, a batting crease of a cricket field, and a tee box of a golf course.

8. A method of visualizing a trajectory of a ball in real-time, comprising,
(a) preparing a plurality of images of a ball, each image of the plurality of images of the ball corresponding to a distance from a reference point;
(b) determining a position of the ball to determine a distance between the ball and the reference point;
(c) selecting an image among the plurality of images, wherein the selected image corresponds to the determined distance; and
(d) using the selected image and determined position, rendering an image of the ball to be displayed on a screen.

9. The method of claim 8, further comprising:
(e) transmitting the rendered image to a broadcast apparatus.

10. The method of claim 8, further comprising:
(f) repeating steps (a)-(e) at each of a plurality of time interval during which the ball moves.

11. The method of claim 8, further comprising:
displaying the images rendered during the plurality of time interval on the screen, to thereby generate a sequence of ball images on the screen in real-time.

12. The method of claim 8, wherein each of the plurality of images is an image of the ball seen from the reference point.

13. The method of claim 8, wherein the step (b) includes:
receiving two or more motion images from two or more cameras;
identifying images of the ball in two or more frames included in the two or more motion images; and
based on the identified images of the ball, determining the position of the ball.

14. A method of claim 8, wherein the reference point is one of a home plate of a baseball field, a batting crease of a cricket field, and a tee box of a golf course.

15. An apparatus for visualizing a ball trajectory, comprising:
two or more cameras for capturing motion images; and
a server communicatively coupled to the two or more cameras, the server including:
an image rendering unit configured to prepare a plurality of images of a ball, each image of the plurality of images of the ball corresponding to a distance from a reference point; and
a position determination unit configured to determine a distance between the ball and the reference point, using two or more frames included in the two or more motion images;
the image rendering unit being configured to select an image among the plurality of images, the selected image corresponding to the determined distance, and, render an image of the ball to be displayed on a screen using the selected image and determined position.

16. The apparatus of claim 15, wherein the server further includes a communication unit for transmitting the image rendered by the image rendering unit to a broadcast apparatus.

17. The apparatus of claim 15, wherein the position determination unit is configured to repeat determining a distance between the ball and the reference point at each of a plurality of time interval during which the ball moves.

18. The apparatus of claim 15, wherein each of the plurality of images is an image of the ball seen from the reference point.

19. The apparatus of claim 15, wherein the position determination unit is configured to:
identify images the ball in two or more frames; and
based on the identified images of the ball, determine the position of the ball.

20. The apparatus of claim 15, wherein the reference point is one of a home plate of a baseball field, a batting crease of a cricket field, and a tee box of a golf course.
